(19) United States
(12) Patent Application Publication
(10) Pub. No.: US 2026/0107332 A1
(43) Pub. Date: Apr. 16, 2026

(54) USING CONNECTIVITY OVER A FIRST NETWORK FOR MANAGEMENT OF A SECOND NETWORK

(71) Applicant: Apple Inc., Cupertino, CA (US)

(72) Inventors: Keith W. RAUENBUEHLER, San Francisco, CA (US); Andreas I. GAL, Portola Valley, CA (US); Christopher J. LEE, Los Altos, CA (US); Venkateswara Rao MANEPALLI, San Jose, CA (US); Wayne A. LEE, Los Altos, CA (US)

(21) Appl. No.: 19/313,855

(22) Filed: Aug. 28, 2025

Related U.S. Application Data
(60) Provisional application No. 63/706,607, filed on Oct. 11, 2024.

(51) Int. Cl. H04W 76/10; H04W 28/04

(52) U.S. Cl. CPC H04W 76/10; H04W 28/04

(57) ABSTRACT

A network device establishes a first network to connect to network-enabled devices. The network device may use the first network to provide a network credential to the network-enabled devices, with the network credential allowing the network-enabled devices to connect to a second network. The first network may monitor the connection, when established, between the second network and the network-enabled devices, and determine whether a fault occurs to the connection(s). The first network may pre-pair the network-enabled devices to the network device via the first network, which allows for the subsequent transmission of data (e.g., network credential) to the network-enabled devices to connect with the second network.

### CROSS REFERENCE TO RELATED APPLICATION(S)

The present application claims the benefit of U.S. Provisional Application No. 63/706,607, entitled “USING CONNECTIVITY OVER A FIRST NETWORK FOR MANAGEMENT OF A SECOND NETWORK”, filed Oct. 11, 2024, the entirety of which is incorporated herein for reference.

### TECHNICAL FIELD

This application is directed to network devices, and more particularly, network devices that utilize connectivity over a first network to manage a second network, such as by providing a network credential for accessing the second network and/or monitoring connections to the second network.

### BACKGROUND

When configuring a network-enabled device on a wireless network, a user may typically provide a network credential (e.g., network ID, network password) to the network-enabled device to connect the network-enabled device to the wireless network. Using this approach, the time required to configure multiple network-enabled devices may scale based on the number of network-enabled devices being configured.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment of a system in which a network hub is in communication with one or more devices via multiple networks, in accordance with aspects of the present disclosure.

FIG. 2 illustrates a block diagram of an example of a network hub that may be used to connect to one or more devices via multiple networks, in accordance with aspects of the present disclosure.

FIG. 3 illustrates a block diagram showing a network hub and one or more devices, further showing an electronic device used to facilitate a connection to a network, in accordance with aspects of the present disclosure.

FIG. 4 illustrates a block diagram showing one or more devices obtaining a network credential to connect the one or more devices to the network hub via the network, in accordance with aspects of the present disclosure.

FIG. 5 illustrates a block diagram showing a network hub connected to one or more devices via an additional network, in accordance with aspects of the present disclosure.

FIG. 6 illustrates a flow diagram showing an example of a process that may be performed for managing a network, in accordance with aspects of the present disclosure.

FIG. 7 illustrates a flow diagram showing an example of a process that may be performed for pre-pairing devices with a network, in accordance with aspects of the present disclosure.

FIG. 8 illustrates a flow diagram showing an example of a process that may be performed for managing a network, in accordance with aspects of the present disclosure.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to network devices (e.g., network hubs) used to establish a first network to which various network-enabled devices may be connected, and subsequently using the first network to provide a network credential to the network-enabled devices, thereby allowing the network-enabled devices to connect to a second network. In an example scenario, the first network may include a mesh network (e.g., Thread network, or generally any mesh network) and the second network may include a WI-FI® network, Ethernet network, or generally any network. Accordingly, the first network and the second network may operate using different network protocols. Network devices described herein may be connected to the first network in parallel with being connected to the second network, which may provide some benefits. For example, while the network-enabled devices are connected to the second network, a network device described herein may use the first network to monitor the connection between the second network and the network-enabled devices. While monitoring the connection with the first network, the network device may detect a fault to the connection between the second network and one or more of the network-enabled devices, and when a fault is detected, the network device may perform functions such as diagnosing (and in some cases, fixing or providing a resolution to) the fault or providing (e.g., to a user) an indication of the fault.

As an example, a home or building may include several network-enabled devices that have been recently installed. A third party installer may use a network device described herein to provision the network-enabled devices and perform a pre-pairing operation used to connect the network-enabled devices to the network device via the first network. The first network may then be used by the third party or an end user (e.g., owner of the network device and network-enabled devices) to subsequently provide a network credential to the network-enabled devices, with the network credential providing authorization and access to connect to the second network. This may include providing the network credential before the second network is established or installed. Put another way, the network device may provide the network credential, via the first network, to the network-enabled devices, and once the second network is established in the home or building, the network-enabled devices may use the network credential to connect to the second network. By providing the network credential to the network-enabled devices, network devices described herein may facilitate connecting the network-enabled devices to the second network with relative ease, as opposed to an end user individually providing the network credential to each of the network-enabled devices. Similar benefits may occur when using the subject system to communicate an update to the network credential for the second network.

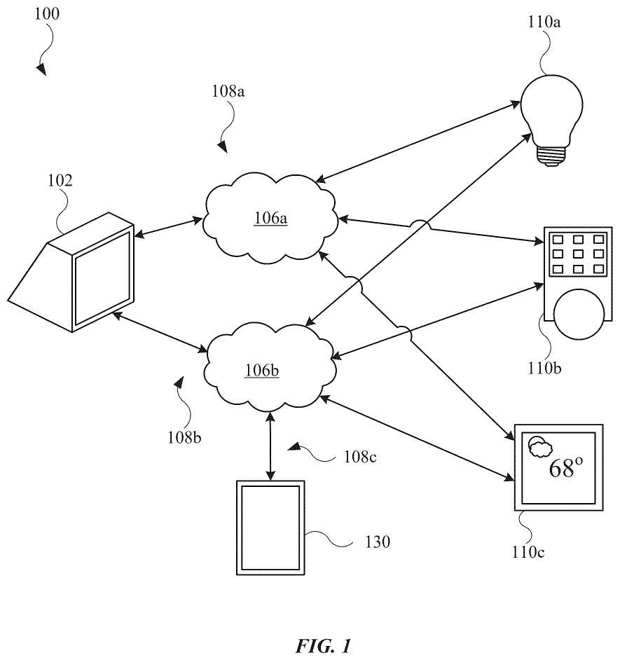

These and other embodiments are discussed below with reference to FIG. 1-9. However, those skilled in the art will readily appreciate that the detailed description given herein with respect to these Figures is for explanatory purposes only and should not be construed as limiting.

FIG. 1 illustrates an example of a network environment 100 of a system in which a network hub 102 is in communication with one or more devices via multiple networks, in accordance with aspects of the present disclosure. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

In addition to the network hub 102, the network environment 100 may include one or more devices (e.g., network-enabled devices), a network 106a and a network 106b. The networks 106a and 106b may be communicatively (directly or indirectly) coupled to the network hub 102 and the one or more devices. For example, a network connection 108a and a network connection 108b may be created and supported based on the network 106a and the network 106b, respectively.

In one or more implementations, the network environment 100 is integrated in a home, office, and/or other common dwelling and/or space. In this regard, the network hub 102 may be referred to as a home network hub, and each of the networks 106a and 106b may be referred to as a home network. Additionally, the network hub 102 may take the form of a network manager, such as a router or an access point. The network hub 102 may take the form of, for example, a home consumer device, or any other appropriate device that includes, for example, one or more wireless interfaces, such as WLAN radios, cellular radios, BLUETOOTH® radios, Zigbee radios, Thread radios, near field communication (NFC) radios, and/or other wireless radios.

The one or more devices includes a network device 110a, a network device 110b, and a network device 110c. The network device 110a may take the form a lightbulb that is part of a lighting system (e.g., smart lighting system). The network device 110b may take the form of a door lock (e.g., smart door lock). The network device 110c may take the form of a thermostat (e.g., smart thermostat). The network devices 110a, 110b, and 110c are non-limiting and representative of additional network-enabled devices, such as a motorized blind and a doorbell (e.g., smart doorbell) that includes a camera. Other types of network devices may also be possible. For example, a network device shown and/or described herein may take the form of, for example, a camera, a security system, a faucet, a motion sensor, a plug/outlet, a motorized blind, and/or generally home device and/or accessory. Generally, each of the network devices 110a, 110b, and 110c may be a “smart” device that may be connected to one or more networks (e.g., the network 106a and/or the network 106b) and as a result may be operated or controlled remotely by the network hub 102. Also, the network devices 110a, 110b, and 110c may include, for example, one or more wireless interfaces, such as WLAN radios, cellular radios, BLUETOOTH® radios, Zigbee radios, Thread radios, near field communication (NFC) radios, and/or other wireless radios.

As shown, the network hub 102 includes a display (not labeled). However, in or more implementations, the network hub 102 may not include a display. The network hub 102 may communicate with one or more of the networks 106a and network 106b and receive updates from any of the network devices 110a, 110b, 110c, and 110c connected to at least one of the network 106a or the network 106b, with the update indicating a change of state of the respective device. For example, the network hub 102 may receive an update that the network device 110b was unlocked (e.g., transitioned from a locked state to an unlocked state). Additionally, the network hub 102 may receive an input (e.g., touch input or gesture to the display, voice command) from a user that is used to change the state of the network devices 110a, 110b, and 110c. For example, the network hub 102 may receive an input from a user to unlock the network device 110b.

In one or more implementations, each of the network devices 110a, 110b, and 110c of the one or more devices is initially provisioned onto the network 106a, thereby allowing the network hub 102 to communicate with the network devices 110a, 110b, and 110c via the network connection 108a. The network 106a may take the form of a mesh network that allows various forms of communication between the network hub 102 and the network devices 110a, 110b, and 110c, as well as communication among the network devices 110a, 110b, and 110c. Further, when the network 106a is established, the network devices 110a, 110b, and 110c may obtain separate network credential for the network 106b, thereby allowing the network devices 110a, 110b, and 110c, to establish the network connection 108b and communicatively couple to the network hub 102 via the network 106b. In this regard, the network 106b may be established at a later time, as compared to establishment of the network 106a. For example, the network 106b may take the form of a WI-FI® network that is established after the network devices 110a, 110b, and 110c are connected to the network hub 102 via the network 106a.

Further, the network hub 102 may use the network 106a to monitor respective connections between the network 106b and the network devices 110a, 110b, and 110c. In this regard, the network 106a may monitor and determine whether a fault has occurred between the network 106b and any one or more of the network devices 110a, 110b, and 110c. As a non-limiting example, a “fault” may refer to disconnection (e.g., connectivity fault, lack of a connection) between the network 106b and any one or more of the network devices 110a, 110b, and 110c. Additionally, the network hub 102 may use the network 106a to query the network credential provided to the network 106b and any one or more of the network devices 110a, 110b, and 110c and in some cases, determine, for example, whether the network credential are the correct network credential, or whether the network devices 110a, 110b, and 110c are connected to the intended network (e.g., the network 106b). Further, the network hub 102 may perform a diagnostic and provide a troubleshooting operation to remedy the fault. Also, the network 106a may provide an indication of (e.g., report) the fault to the network hub 102, allowing a user to receive the indication of the fault via a display or an audio speaker (not shown in FIG. 1) of the network hub 102.

Additionally, an electronic device 130 may be connected to the network 106b via a network connection 106c. The electronic device 130 may function as another device used to communicate and control the network devices 110a, 110b, and 110c. As a non-limiting example, the electronic device 130 takes the form of a mobile wireless communication device (e.g., smartphone, tablet computing device, laptop computing device).

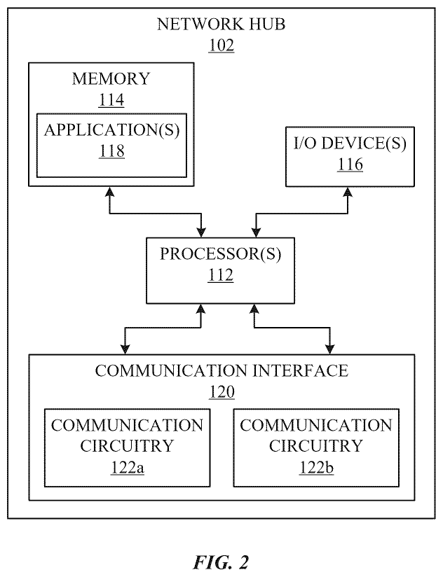

FIG. 2 illustrates a block diagram of an example of a network hub 102 that may be used to connect to one or more devices (e.g., network devices network devices 110a, 110b, and 110c shown in FIG. 1) via multiple networks (e.g., networks 106a and 106b shown in FIG. 1), in accordance with aspects of the present disclosure. The network hub 102 shown in FIG. 1 may be implemented in any other electronic device for use with the subject technology. In this regard, the network hub 102 may be used with smart home automation and may also function to control and cause a change of state of network devices. Variations in the arrangement and type of the components may be made without departing from the spirit or scope of the claims as set forth herein. Additional components, different components, or fewer components may be provided.

The network hub 102 may include one or more processors 112, a memory 114, one or more input-output devices 116 (I/O devices(s)), and a communication interface 120. The one or more processors 112 may include a central processing unit, a graphics processing unit, one or more microcontrollers, one or more application specific integrated circuits, or a combination thereof. Further, the one or more processors 112 may include suitable logic, circuitry, and/or code that enable processing data and/or controlling operations of the network hub 102. In this regard, the one or more processors 112 may be enabled to provide control signals to various other components of the network hub 102. The one or more processors 112 may also control transfers of data between various portions of the network hub 102. The one or more processors 112 may further implement an operating system or may otherwise execute code to manage operations of the network hub 102. The one or more processors 112 may communicatively couple to the one or more devices (shown in FIG. 1).

The memory 114 may include suitable logic, circuitry, and/or code that enable storage of various types of information such as received data, generated data, code, and/or configuration information. The memory 114 may include volatile memory (e.g., random access memory (RAM)) and/or non-volatile memory (e.g., read-only memory (ROM), flash, and/or magnetic storage). In one or more implementations, the memory 114 may store user account data, and any other data generated in the course of performing the processes described herein.

The memory 114 may store one or more applications 118. The one or more applications 118 may include an application used to communicate with and control one or more network devices. In this regard, the one or more applications 118 may include an application that communicates with one or more network devices (e.g., network devices 110a, 110b, and 110c shown in FIG. 1). Further, using the one or more applications 118, the network hub 102 may establish automation and generate one or more automated controls used to control a network device to provide an automated change of a state of the network device based upon predetermined conditions, such as turning on a lighting system at a preset time or turning off the lighting system at a preset time, as non-limiting examples.

The one or more input-output devices 116 may include a display. In one or more implementations, the display includes a capacitive touch input display, thus allowing the user to interact with the network hub 102 via a touch input or gesture to the display. Additionally, the one or more input-output devices 116 may include one or more buttons, which may be actuated by a user of the network hub 102. The one or more input-output devices 116, while taking the form of a display and/or buttons, may be used to provide an input to the one or more processors 112 in order to, for example, turn on, turn off, or dim a light(s). Further, the one or more input-output devices 116 may include an audio module (e.g., speaker) designed to convert electrical signals into soundwaves in the form of audible sound. The one or more input-output devices 116 may include one or more microphones and/or cameras. The microphones may obtain audio signals, such as voice commands from a user to initiate a voice command to, for example, change a state of a network device. For example, the microphones may obtain audio of the user providing a command to lock a door. The one or more input-output devices 116 may be used to provide an indication of a fault to a network (e.g., network 106b shown in FIG. 1) or a network connection (e.g., network connection 108b shown in FIG. 1).

The communication interface 120 may include suitable logic, circuitry, and/or code that enables wired or wireless communication. As shown, the communication interface 120 include communication circuitry 122a and communication circuitry 122b. The communication circuitry 122a may be used to establish the network 106a (shown in FIG. 1) and the communication circuitry 122b may be used to connect to connect to the network 106b (shown in FIG. 1). In one or more implementation, the communication circuitry 122a takes the form of one or more of a BLUETOOTH® communication interface, an NFC interface, a Zigbee communication interface, a Thread interface, a WLAN communication interface, a Universal Serial Bus (USB) communication interface, or a cellular interface. Further, in one or more implementations, the communication circuitry 122b takes the form of WI-FI® communication interface. In this regard, each of the communication circuitry 122a and the communication circuitry 122b may operate using a different network protocol (e.g., different wireless network protocols). Each of the communication circuitry 122a and the communication circuitry 122b may establish a respective radio network, allowing the network hub 102 to communicate with devices (e.g., the network devices 110a, 110b, and 110c shown in FIG. 1) via each of the radio networks. Also, while the communication circuitry 122a and the communication circuitry 122b are shown as separate components, the communication circuitry 122a and the communication circuitry 122b may combine to function as a shared radio.

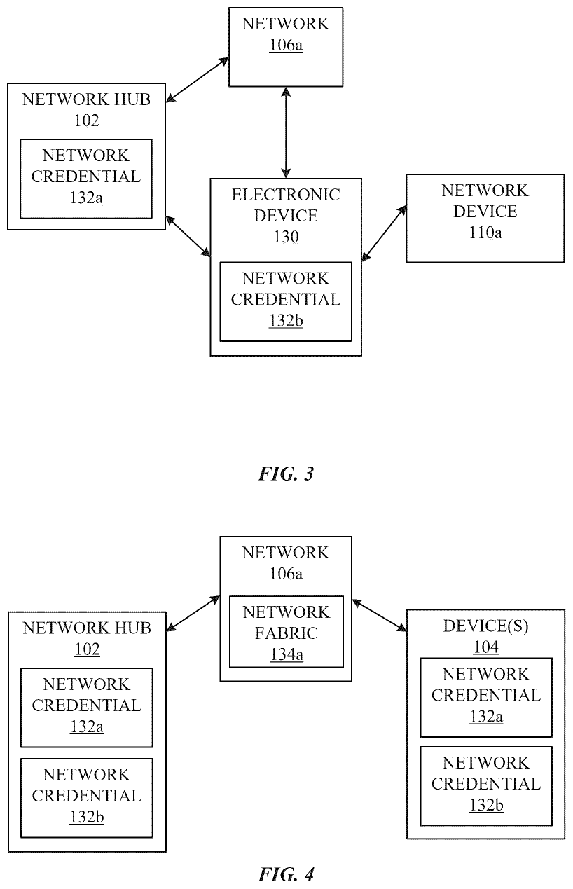

FIG. 3 illustrates a block diagram showing a network hub 102 and one or more devices, further showing an electronic device 130 used to facilitate connection to a network 106a, in accordance with aspects of the present disclosure. In one or more implementations, the electronic device 130 may be utilized to provision each device (e.g., the network devices 110a, 110b, and 110c shown in FIG. 1) of the one or more devices onto the network 106a such that a network connection (e.g., network connection 108a shown in FIG. 1) may be established between the network hub 102 and the one or more devices via the network 106a. The network device 110a shown in FIG. 3 is a representative device of other network devices shown and/or described herein. In one or more implementations, the electronic device 130 is used by a third party (e.g., installer) to provision the network device 110a. Put another way, an end user of the network hub 102 and the network device 110a may be different from the third party.

According to one approach, the electronic device 130 obtains information from the network hub 102 to provide to the network device 110a. For example, the electronic device 130 may scan a code (e.g., QR code) on the network hub 102, allowing the electronic device 130 to obtain network credential 132a from the network hub 102 and subsequently transfer the network credential 132a to the network device 110a, such as by similarly scanning a QR code on each of the one or more devices to connect directly to each of the one or more devices. When the network device 110a receives the network credential 132a, the network device 110a may connect to the network 106a and communicate with the network hub 102.

In one or more implementations, the electronic device 130 can be used to set up a network fabric on the network 106a. The network fabric may be used to connect the devices of the one or more devices to the network hub 102. The network fabric may be used to efficiently transfer the network credential 132a to the devices of the one or more devices by, for example, allowing the network credential 132a to be transferred from device to device (e.g., among the network devices 110a, 110b, and 110c shown in FIG. 1). Alternatively, the electronic device 130 may individually provide the network credential 132a to the network device 110a.

Additionally, the electronic device 130 may provide network credential 132b to at least one of the network hub 102 or the network device 110a, with the network credential 132b being used to connect to an additional network (e.g., network 106b shown in FIG. 1). This may include instances when the additional network is not established (e.g., not established in the network environment 100 shown in FIG. 1). As a pre-pairing operation, the network hub 102 and/or the network device 110a may obtain the network credential 132b prior to setting up the additional network that uses the network credential 132b. Using the pre-pairing operation allows the network device 110a to have an existing connection over the network 106a that a user can later use to supply her own network credential to create, for example, a WI-FI® access point name and login. Also, the user can also subsequently roll the network device 110a (and other network devices) to a different network fabric such that the third party installer cannot access the devices still on the network 106a. Alternatively, the network credential 132b may be added to the network hub 102 and/or the one or more devices by other approaches (e.g., user-provided credential provided directly to each device without the use of the electronic device 130).

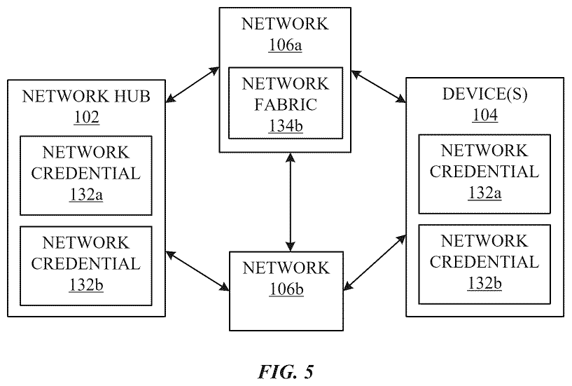

FIG. 4 illustrates a block diagram showing one or more devices obtaining network credential 132a to connect the one or more devices to the network hub 102 via the network 106a, in accordance with aspects of the present disclosure. Additionally, the one or more devices obtain the network credential 132a and connect to the network 106a, allowing the network hub 102 communicate with the one or more devices via the network 106a. Also, each of the network hub 102 and the one or more devices obtain the network credential 132b allowing the network hub 102 and the one or more devices to connect to an additional network (e.g., network 106b shown in FIG. 1). Also, the one or more devices may be connected to the network 106a via the network fabric 134a established by the electronic device 130 (shown in FIG. 3).

FIG. 5 illustrates a block diagram showing the network hub 102 connected to the one or more devices via the network 106a and the network 106b, in accordance with aspects of the present disclosure. As shown, each of the network hub 102 and the one or more devices are connected to the network 106a and the network 106b via the network credential 132a and the network credential 132b, respectively. Additionally, the one or more devices may be connected to the network 106a via a network fabric 134b, such as using a different network credential than the network credential 132a. As a non-limiting example, the network fabric 134b may be established over the network 106a based in part of the network hub 102. Further, the network fabric 134a (shown in FIG. 4) may be removed, or evicted, once the network fabric 134b is established over the network 106a. As a result, the prior third party may be limited or prohibited from accessing the network hub 102, the one or more devices, and/or the networks 106a and 106b. In this regard, access to the one or more devices via the network hub 102 is generally limited to the end user.

Also, the network 106a may be used to monitor the respective connections between the network 106b and the one or more devices. For example, the network 106a may take the form of a mesh network (e.g., Thread network) and the network 106b may take the form of a WI-FI® network. The network hub 102 may use the network 106a may monitor the respective connections between the network 106b and the one or more devices to query the respective connections to determine, for example, the signal strength of the connections, and/or whether the respective connections are the intended/proper connections. Alternatively or in combination, the network hub 102 may use the network 106a to monitor the respective connections between the network 106b and the one or more devices to diagnose the respective connections. In some instances, the diagnostic step may include updating the network credential 132b and/or the network name associated with the network credential 132b. Accordingly, the diagnostic step may include fixing the network connection between the network 106b and the one or more devices by providing a resolution to the network connection. The network hub 102 may provide an indication of a fault to network 106b or a network connection (e.g., network connection 108b shown in FIG. 1) of the network 106b.

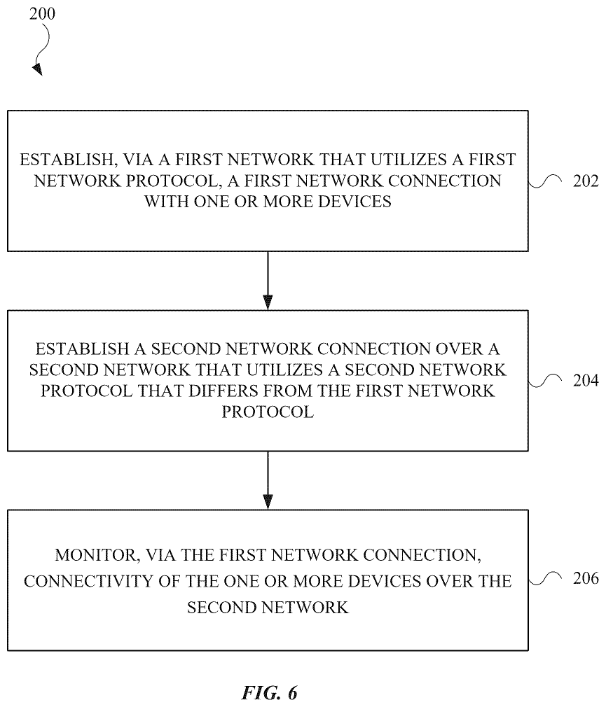

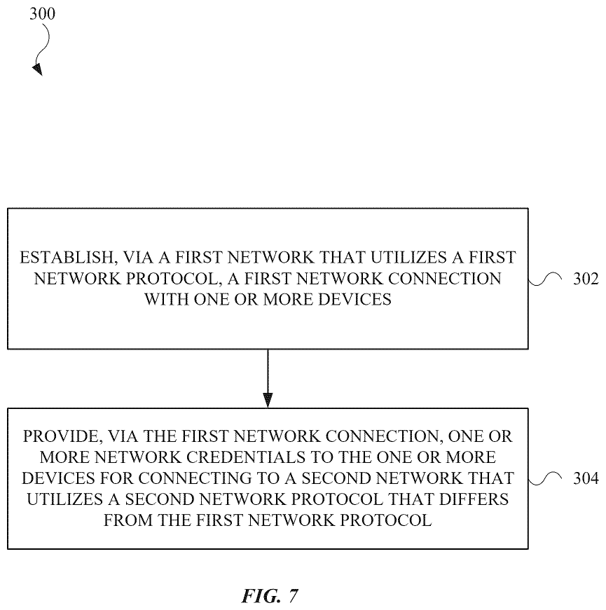

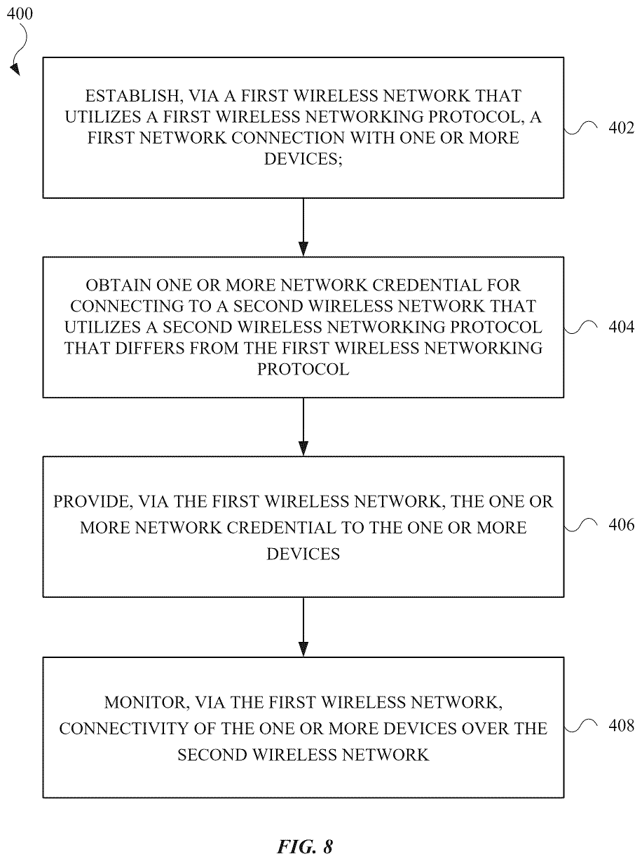

FIG. 6, FIG. 7, and FIG. 8 illustrate flow diagrams showing examples of one or more processes that may be performed network connection functions, in accordance with implementations of the subject technology. One or more devices, including one or more processors thereof and computer-readable instructions stored thereon, such as network hubs (e.g., network hub 102 shown in FIGS. 1-5) or one or more home networks (e.g., network 106a shown in FIGS. 1, 3, 4, and 5, network 106b shown in FIGS. 1 and 5), may be used in part to conduct one or more steps of the example processes. For explanatory purposes, the respective processes shown in FIGS. 6, 7 and 8 are primarily described herein with reference to the network hub 102 or the networks 106a and 106b. However, the respective processes shown in FIGS. 6 and 7 are not limited to the network hub 102, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 6 illustrates a flow diagram showing an example of a process 200 that may be performed for managing a network, in accordance with aspects of the present disclosure.

At block 202, a first network connection (e.g., network connection 108a shown in FIG. 1) with one or more devices (e.g., network devices 110a, 110b, and 110c shown in FIG. 1) is established via a first network (e.g., network 106a shown in FIG. 1). The network connection may be used to provide a network credential for a second network.

At block 204, a second network connection (e.g., network connection 108b shown in FIG. 1) is established over a second network (e.g., network 106b shown in FIG. 1) that utilizes a second network protocol that differs from the first network protocol At block 206, connectivity of the one or more devices over the second network is monitored via the first network connection. This may include monitoring for a fault in the second network connection. In one or more implementations, the fault is diagnosed to determine the issue and may be subsequently fixed.

FIG. 7 illustrates a flow diagram showing an example of a process 300 that may be performed for pre-pairing devices with a network, in accordance with aspects of the present disclosure.

At block 302, a first network connection (e.g., network connection 108a shown in FIG. 1) with one or more devices (e.g., network devices 110a, 110b, and 110c shown in FIG. 1) is established via a first network (e.g., network 106a shown in FIG. 1) that utilizes a first network protocol.

At block 304, one or more network credentials is provided, via the first network connection, to the one or more devices for connecting to a second network (e.g., network 106b shown in FIG. 1) that utilizes a second network protocol that differs from the first network protocol.

FIG. 8 illustrates a flow diagram showing an example of a process 400 that may be performed for managing a network, in accordance with aspects of the present disclosure.

At block 402, a first network connection (e.g., network connection 108a shown in FIG. 1) with one or more devices (e.g., network devices 110a, 110b, and 110c shown in FIG. 1) is established via a first wireless network (e.g., network 106a shown in FIG. 1) that utilizes a first wireless networking protocol.

At block 404, one or more network credentials are obtained for connecting to a second wireless network (e.g., network 106b shown in FIG. 1) that utilizes a second wireless networking protocol that differs from the first wireless networking protocol.

At block 406, the one or more network credentials are provided, via the first wireless network, to the one or more devices.

At block 408, connectivity of the one or more devices over the second wireless network is monitored via the first wireless network.

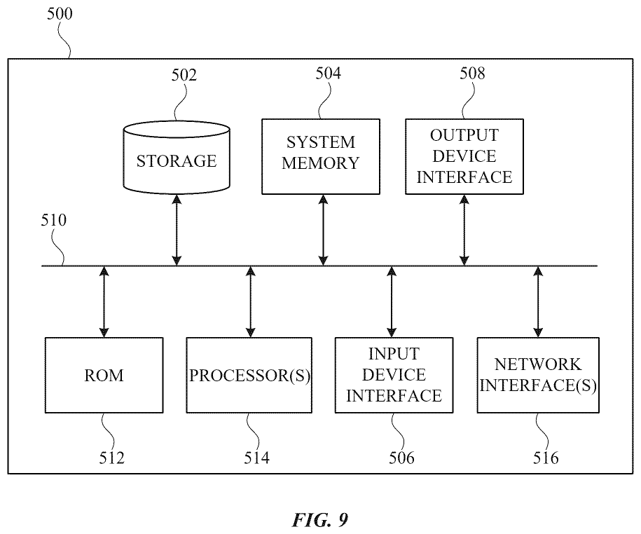

FIG. 9 illustrates an electronic system 500 with which one or more implementations of the subject technology may be implemented. The electronic system 500 can be, and/or can be a part of, the network hub 102 or the networks 106a and 106b as shown in FIG. 1. The electronic system 500 may include various types of computer readable media and interfaces for various other types of computer readable media. The electronic system 500 includes a bus 510, one or more processing units 514, a system memory 504 (and/or buffer), a ROM 512, a permanent storage device 502, an input device interface 506, an output device interface 508, and one or more network interfaces 516, or subsets and variations thereof.

The bus 510 collectively represents all system, peripheral, and chipset buses that communicatively connect the numerous internal devices of the electronic system 500. In one or more implementations, the bus 510 communicatively connects the one or more processing units 514 with the ROM 512, the system memory 504, and the permanent storage device 502. From these various memory units, the one or more processing units 514 retrieves instructions to execute and data to process in order to execute the processes of the subject disclosure. The one or more processing units 514 can be a single processor or a multi-core processor in different implementations.

The ROM 512 stores static data and instructions that are needed by the one or more processing units 514 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing units 514 may need at runtime. In one or more implementations, the processes of the subject disclosure are stored in the system memory 504, the permanent storage device 502, and/or the ROM 512 (which are each implemented as a non-transitory computer-readable medium). From these various memory units, the one or more processing units 514 retrieves instructions to execute and data to process in order to execute the processes of one or more implementations.

The bus 510 also connects to the input device interface 506 and output device interface 508. The input device interface 506 enables a user to communicate information and select commands to the electronic system 500. Input devices that may be used with the input device interface 506 may include, for example, alphanumeric keyboards and pointing devices (also called “cursor control devices”). The input device interface 506 may enable, for example, the display of images generated by electronic system 500. Output devices that may be used with the input device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 510 also couples the electronic system 500 to one or more networks and/or to one or more network nodes, such as the network hub 102 and network devices 110a, 110b, and 110c shown in FIG. 1, through the one or more network interfaces 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for managing a network using another network. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for managing a network using another network.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of managing a network using another network, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
establishing, via a first network that utilizes a first network protocol, a first network connection with one or more devices;
establishing a second network connection over a second network that utilizes a second network protocol that differs from the first network protocol; and
monitoring, via the first network connection, connectivity of the one or more devices over the second network.

2. The method of claim 1, further comprising:
in response to detecting, based on the monitoring, a connectivity fault for one of the one or more devices over the second network, providing an indication of the connectivity fault.

3. The method of claim 1, further comprising:
in response to detecting, based on the monitoring, a connectivity fault for one of the one or more devices over the second network, providing, via the first network, a diagnostic for the connectivity fault.

4. The method of claim 1, further comprising:
providing, over the second network, a command to change a state a network device of the one or devices.

5. The method of claim 1, wherein establishing the first network connection with the one or more devices comprises establishing, via a first network fabric over the first network, the first network connection with the one or more devices.

6. The method of claim 5, further comprising:
establishing, via a second network fabric over the first network, the first network connection with the one or more devices; and
removing the one or more devices from the first network fabric.

7. The method of claim 1, further comprising in response to obtaining an update to a network credential, providing, via the first network, the update to the one or more devices.

8. The method of claim 1, wherein monitoring, via the first network connection, the connectivity comprises querying, via the first network, the one or more devices.

9. The method of claim 1, wherein:
establishing, via the first network, the first network connection comprises establishing, via a first communication circuitry, the first network connection; and
establishing the second network connection comprises establishing, via second communication circuitry that differs from the first communication circuitry, the second network.

10. A non-transitory computer-readable medium, comprising:
computer-readable instructions that, when executed by a processor, cause the processor to perform one or more operations comprising:
establishing, via a first network that utilizes a first network protocol, a first network connection with one or more devices; and
providing, via the first network connection, one or more network credentials to the one or more devices for connecting to a second network that utilizes a second network protocol that differs from the first network protocol.

11. The non-transitory computer-readable medium of claim 10, further comprising prior to obtaining the one or more network credentials establishing via the first network, the first network connection.

12. The non-transitory computer-readable medium of claim 10, further comprising prior to availability of the second network connection, via the second network, with the one or more devices, providing, via the first network, the network credential to the one or more devices.

13. The non-transitory computer-readable medium of claim 10, further comprising in response to an establishment of the second network, via the one or more network credentials, between the one or more devices and the second network, monitoring, via the first network connection, connectivity of the one or more devices over the second network.

14. The non-transitory computer-readable medium of claim 13, wherein in response detecting a fault, based on the monitoring, providing, via the first network, a diagnostic of the fault.

15. The non-transitory computer-readable medium of claim 13, further comprising in response to obtaining an update to the one or more network credentials, providing, via the first network, the update to the one or more devices.

16. The non-transitory computer-readable medium of claim 10, wherein:
the first network comprises via a first network protocol, and
the second network comprises a second network protocol different from the first network protocol.

17. A system, comprising:
a memory; and
a processor configured to:
establish, via a first wireless network that utilizes a first wireless networking protocol, a first network connection with one or more devices;
obtain one or more network credential for connecting to a second wireless network that utilizes a second wireless networking protocol that differs from the first wireless networking protocol;
provide, via the first wireless network, the one or more network credentials to the one or more devices; and
monitor, via the first wireless network, connectivity of the one or more devices over the second wireless network.

18. The system of claim 17, wherein the processor is further configured to:
in response to detecting, based on the monitoring, a connectivity fault for one of the one or more devices over the second network, providing an indication of the connectivity fault.

19. The system of claim 18, wherein the processor is further configured to:
in response to detecting, based on the monitoring, a connectivity fault for one of the one or more devices over the second network, providing, via the first network, a diagnostic for the connectivity fault.

20. The system of claim 17, further comprising a display, wherein the processor is further configured to in response to detection of a fault, via the monitoring, provide an indication of the fault at the display.
